(19) United States
(12) Patent Application Publication
(10) Pub. No.: US 2013/0206688 A1
(43) Pub. Date: Aug. 15, 2013

(54) Process And System For The Treatment Of Industrial And Petroleum Refinery Wastewater

(71) Applicants: Muftah Hassan El-Naas, Al-Ain (AE); Sulaiman Abdulrazak Al-Zuhair, Al-Ain (AE)

(72) Inventors: Muftah Hassan El-Naas, Al-Ain (AE); Sulaiman Abdulrazak Al-Zuhair, Al-Ain (AE)

(21) Appl. No.: 13/676,755

(22) Filed: Nov. 14, 2012

(30) Foreign Application Priority Data
Feb. 13, 2012 (GB) 1202411.3

(51) Int. Cl. C02F 9/00

(52) U.S. Cl. CPC C02F 9/00
USPC 210/631; 210/243

(57) ABSTRACT

There is provided a process of reducing concentration of contaminants in a contaminated wastewater stream, such as contaminated wastewater output from a refinery, such as an oil-refinery; the process comprising: first, passing the contaminated wastewater stream into an electrocoagulation reactor for coagulating dispersed particles, filtering the wastewater stream after electrocoagulation for removing the coagulated dispersed particles, and providing a first stream of treated wastewater after the first filtration; second, passing the first stream of treated wastewater into a Spouted Bed Bio-Reactor (SBBR) containing a micro-organism or bacterium immobilized in polyvinyl alcohol (PVA) gel, filtering the first stream after treatment by the SBBR and providing a second stream of treated wastewater after the second filtration; and third, passing the second stream of treated wastewater into an adsorption column containing granular activated carbon (GAC) and providing a third stream of treated wastewater. There is also provided a system for doing the same.

### CROSS-REFERENCE

This application claims foreign priority under 35 U.S.C. §119 to British Patent Application No. 1202411.3, filed Feb. 13, 2012, which is hereby incorporated herein by reference.

### FIELD OF THE INVENTION

The present invention pertains generally to the field of treatment of industrial and petroleum refinery wastewater and more particularly to a process and a system for the treatment of industrial and petroleum refinery wastewater by reducing concentrations of COD, phenols and cresols.

### BACKGROUND OF THE INVENTION

Wastewater generated by chemical plants including petroleum refineries is often characterized by high concentrations of aliphatic and aromatic petroleum hydrocarbons, which usually have detrimental and harmful effects on plants and aquatic life as well as the quality of surface and ground water sources.

Petroleum refinery industry converts crude oil into more than 2500 refined products, in which large volume of wastewater is produced during the different refinery processes. Refinery wastewater is characterized by high levels of chemical oxygen demand (COD) and phenols of approximately 1000-6000 ppm and 10-200 ppm, respectively. The Environmental Protection Agency (EPA) places limits on the allowable levels of these pollutants in industrial wastewater effluent streams. Therefore, processes for reducing the content of the organic and inorganic contaminants, in the wastewater streams, to acceptable levels have been employed to comply with these standards.

Wastewater facilities in these plants usually rely on many expensive pretreatment steps to reduce the concentration of these contaminants before any final biological purification step. These pretreatment units may include ultrafiltration, adsorption, coagulation and electrochemical process (Water Res. 32 (1998) 3495-3499).

One of the most common techniques used for refinery wastewater treatment is the Reverse Osmosis. U.S. Pat. No. 5,250,185 describes a method for treating oil-field produced water that contains boron and solubilized hydrocarbon compounds to substantially reduce the boron concentration in the liquid. The method involves removing divalent cations from the liquid by adding a water softener and adjusting the pH of the water up to 9.5, and then passing the liquid through a reverse osmosis membrane to recover the treated water from the lower pressure side of the membrane. Similar process for removing soluble and insoluble organic and inorganic contaminants from refinery wastewater streams employing ultrafiltration and reverse osmosis is described in U.S. Pat. No. 6,054,050. The permeate from the ultrafiltration step is first passed through a sequential softening system to remove divalent and trivalent metal cations prior to being passed through a reverse osmosis step to prevent fouling therein. Another similar process is described in U.S. Pat. No. 5,376,262, wherein reverse osmosis process is used to reduce the concentration of inorganic contaminants in a refinery wastewater stream.

Centrifuges have also been used in the treatment of refinery wastewater. U.S. Pat. No. 6,132,630 describes a method for separating oil (e.g. heavy oil and/or light oil), undesirable organic material (solid and/or liquid), and contaminated solids from refinery wastewater using chemical coagulation with two consecutive units. Wastewater stream is first passed through a first centrifuge for centrifugal separation, and then the output stream is further treated using a second centrifuge, producing a resultant centrifuged stream of recoverable oil and treated water phase, which can be further treated or recycled back.

Another technique commonly used for the treatment of refinery wastewater is chemical coagulation. This technique involves the addition of chemicals such as Alum [Al₂(SO₄)₃.18H₂O] to an aqueous solution to combine small dispersed particles into larger agglomerates, which can then be removed by other methods such as sedimentation, air flotation, or filtration. Coagulation can also be accomplished by the in-situ generation of coagulants of highly charged polymeric metal hydroxide species by electrolytic oxidation of an appropriate anode material. These species neutralize the electrostatic charges on suspended solids and oil droplets to facilitate agglomeration or coagulation and prompt the precipitation of certain metals and salts. This technique is referred to as electrocoagulation (Environ. Sci. Technol 60 (2006) 6418-6424), which is efficient in removing suspended solids as well as oil and greases. It can also remove metals, colloidal solids and particles, and soluble inorganic pollutants from aqueous media.

Some of the advantages of the electrocoagulation are the simple equipment, the easy automation of the process and not requiring addition of chemicals (Environ. Sci. Technol 60 (2006) 6418-6424). The dosing of coagulant reagents depends usually on the cell potential (or current density) applied. Other advantages include the promotion in the flocculation process, caused by the turbulence generated by the oxygen and the hydrogen evolution that produces a soft mix, and helps the destabilized particles generate bigger particles. In addition, the formed oxygen and hydrogen bubbles increase the efficiency of the separation process through electroflotation. In recent years, there has been increased interest in the application of electrocoagulation in the treatment and purification of industrial wastewater (J. Haz. Mater. 142 (2007) 58-6; Water Sci. Technol. 25 (1992) 247-252). In spite of the considerable success of electrocoagulation for the treatment of various types of wastewater, its application as a possible technique for the treatment of petroleum refinery wastewater is rather scarce in the literature.

Phenol and its derivatives are among the most toxic organic pollutants. They are carcinogenic at relatively low levels of 5-25 mg L⁻¹ (Biotechnol. Bioeng. 26 (1984) 599-603). In addition, they have an objectionable tastes and odors even at a very low level of 2.0 μg L⁻¹. Phenols are major constituents in the wastewater of most chemical and petroleum industries and often require proper treatment before being discharged. The treatment alternatives such as ion exchange, solvent extraction, and chemical oxidation often suffer from serious drawbacks including high cost. In addition, most of these techniques do not degrade the phenol, but rather remove it from the wastewater and pass it to another phase, which result in the formation of hazardous by-products (secondary pollution) (Water Resour. 1 (1967) 587-597). For example, U.S. Pat. No. 5,705,074, described the removal of phenolics and COD from refinery wastewater by extraction with a hydrocarbon solvent containing at least about 2% by weight of trialkylamine.

Biodegradation provides a more environmental friendly and cost effective alternative. A large number of studies on the degradation of phenols by Pseudomonas putida have been carried out because of its high removal efficiency (Proc. Biochem. 38 (2003) 1497-1507; Water Resour. 36 (2002) 2443-2450; Proc. Biochem. 40 (2005) 1233-1239). P. putida has been studied by many researchers in free and immobilized forms in different types of bioreactors. For example, Gonzalez et al (Bioresource Technol. 80 (2001) 137-142) investigated the biodegradation of phenolic industrial wastewaters by a pure culture of P. putida (ATCC 17484) immobilized by entrapment in calcium-alginate gel beads hardened with Al³⁺. The experiments were carried out in batch and continuous mode in a fluidized-bed bioreactor. On the other hand, Kumar et al (Biochem. Eng. J. 22 (2005) 151-159) used free pure culture of P. putida (MTCC 1194) in shaken batch bioreactor. Immobilization of bacterial biomass is an effective technique, usually employed to protect the bacteria from high phenol concentrations, which causes substrate inhibition, and to allow reutilization.

The key problem in microorganism immobilization, used for the biodegradation of phenol from wastewater, is the immobilization supports, which are usually biodegradable, toxic, expensive and have low mechanical strength and surface area. Several attempts have taken place to overcome these problems, such as the immobilization technique described in U.S. Pat. No. 6,406,882, wherein coconut fibers are used as a support for immobilization of microbial consortium. The immobilization support is claimed to have a high biodegradation resistance and a large surface area that allows the adsorption of higher number of cells. In addition, it is non-toxic and mechanically strong.

Numerous studies on the treatment of wastewater containing phenol have focused on employing and exploring new types of bioreactors with high performance for practical utilization. These included the use of hollow fiber membrane contactors (Chemosphere 66 (2007) 191-198; J. Membrane Sc. 313 (2008) 207-216), fluidized bed bioreactor (Bioresour. Technol. 80 (2001) 137-142; J. Haz. Mat. 8136 (2006) 727-734) and fixed-biofilm process (J. Haz. Mat. 172 (2009) 1394-1401). Other novel bioreactors that have been developed for other biotreatment applications include rotating rope bioreactor (Bioresour. Technol. 99 (2008) 1044-1051), two phase partitioning bioreactor (Trends Biotechnol. 19 (2001) 457-462) and foam emulsion bioreactor (Biotechnol. Bioeng. 84 (2003) 240-244). However, most of these reactors have difficulty in long term operation and scale-up which limit their practical application in any industrial process.

The Spouted Bed Bio-Reactor (SBBR) is characterized by a systematic intense mixing due the cyclic motion of particles within the bed, which is generated by a single air jet injected through an orifice in the bottom of the reactor. It has many advantages over the conventional bubble column and other flow bioreactors, including better mixing and contact between substrate and cells, and faster oxygen transfer rate, which lead to higher rates of phenol removal.

Since large amounts of non-biodegradable organic compounds are present in the industrial wastewater, the effluent from a biodegradation treatment step may still have a considerable amount of COD at levels approaching that of the raw wastewaters. This is particularly true with regard to bio-resistant contaminants such as halogenated hydrocarbons and nitrated hydrocarbons, which are commonly present in petroleum refineries and organic chemical manufacturing wastewaters. Thus, even when the biological treatment are operating under optimum conditions, the amount of organic contaminants removed may not be sufficient to meet the standards presently being established. As a consequence, there is a need for further treating of the effluents from such units, in order to improve the overall process for treating industrial wastewater.

In order to remove organic contaminants from wastewater, and the effluents from the biological treatment step, adsorption on activated carbon has been proposed. U.S. Pat. No. 3,244,621, U.S. Pat. No. 3,455,820 and U.S. Pat. No. 3,658,697 describe similar methods for removing organic soluble impurities from wastewater using a bed of activated carbon. The high cost associated with commercial activated carbon as an effective adsorbent has lead to the search for a less expensive activated carbon of properties comparable to those of the commercially available. Recently, date-pits (DP) have received considerable attention as a lignin-origin material for preparing low cost activated carbon. DP constitutes approximately 10% of the total weight of dates (Food Chem. 76 (2002) 135-137), making them the largest agricultural by-product in palm growing countries, including the UAE (J. Haz. Mat. 173 (2010) 750-757).

Several studies have examined different DP activation processes including physical (J. Haz. Mat. 158 (2008) 300-307; Adsorp. Sci. Technol. 21 (2003) 245-260) and chemical means (Adsorp. Sci. Technol. 21 (2003) 597-606; Waste Manag. 26 (2006) 651-660). El-Naas et al (J. Haz. Mat. 173 (2010) 750-757; J. Haz. Mat. 158 (2008) 300-307) have reported that physically activated Date-Pit has properties and adsorption capacities comparable to those of commercial activated carbon. Physically activated DP was evaluated for the adsorption of phenol from synthetic aqueous solutions and proved to have adsorption capacity of 16 times higher than that of non-activated date pits (Chem. Eng. Technol. 27 (2004) 80-86).

A single process alone may not be adequate for the treatment of wastewater contaminated with organic compounds. Hence, a combination of two or more treatment methods for the complete and successful removal of the pollutants have been experimented. Combination between electrochemical treatment and adsorption on activated carbon has been reported for removing chlorinated organic compounds from wastewater (J. Env. Sci. (2005) 1-9) and also for the removal of chromium from synthetic effluents (J. Haz. Mat. 161 (2009) 575-580). This combination was found to be highly efficient and relatively fast compared to the existing conventional techniques; however it still suffered from rapid saturation for the adsorption column.

### SUMMARY OF THE INVENTION

Therefore, there is provided a process and a system for reducing the concentration of contaminants contained in a contaminated wastewater stream that would overcome the above-mentioned drawbacks.

Since refinery wastewater is highly contaminated with organic matter, expressed by the high COD contents and phenolics concentrations, an integrated system consisting of electrocoagulation reactor, followed by spouted bed bioreactor and adsorption column packed with granular activated carbon (GAC) is proposed to effectively treat refinery wastewater. This combination has proved to be efficient for the reduction of COD and phenolic compounds.

The invention provides a process for the reduction of organic and inorganic contaminants expressed by the chemical oxygen demand (COD), phenol and cresols from refinery or industrial wastewater. The process is carried out by using the three treatment units in series. The wastewater is treated first in an electrocoagulation reactor (EC) that has two electrodes, oppositely charged using a DC voltage source. The effluent from the EC passes through a filter, and then treated in a spouted bed bioreactor (SBBR), which contains bacteria immobilized in polyvinyl alcohol (PVA) particles. The effluent from the SBBR is passed through a filter and then treated in an adsorption column (AD), which contains activated carbon produced from agricultural waste, date pits. The electrocoagulation reactor (EC) can have metal electrodes, that can be aluminum or steel.

The process consists of three different treatment techniques arranged in series for the treatment of highly polluted refinery wastewater. The refinery wastewater is first fed to an electrocoagulation cell then passed through a spouted bed bioreactor and finally sent to a polishing step using adsorption column packed with activated carbon derived from date pits.

Several combinations of the three units were tested to optimize the process efficiency and maximize the removal of pollutants. At first, wastewater was treated by each unit separately and the percent removal of pollutants was observed. The results were then compared to those obtained using a combination of more than one unit and under different arrangements and different operation conditions.

As a first aspect of the invention, there is provided a process of reducing concentration of contaminants contained in a contaminated wastewater stream from a refinery, such as an oil-refinery; the process is comprising: first, passing the contaminated wastewater stream into an electrocoagulation reactor for coagulating dispersed particles contained in the contaminated wastewater, filtering the wastewater stream after electrocoagulation for removing the coagulated dispersed particles, and providing a first stream of treated wastewater; second, passing the first stream of treated wastewater into a Spouted Bed Bio-Reactor (SBBR) containing a micro-organism or bacterium immobilized in polyvinyl alcohol (PVA) gel, filtering the first stream after treatment by the SBBR and providing a second stream of treated wastewater; and third, passing the second stream of treated wastewater into an adsorption column containing granular activated carbon (GAC), filtering the second stream after adsorption and providing a third stream of treated wastewater.

As a further aspect of the invention, there is provided a system for reducing concentration of contaminants contained in a contaminated wastewater stream from a refinery, such as an oil-refinery; the system comprising: an electrocoagulation reactor adapted to be connected to a source of contaminated wastewater stream for coagulating dispersed particles contained in the contaminated wastewater; a first settling tank, pump and filter connected to the electrocoagulation reactor for filtering the wastewater stream after electrocoagulation by removing the coagulated dispersed particles and for providing a first stream of treated wastewater; a Spouted Bed Bio-Reactor (SBBR) connected to the first filter for receiving the first stream of treated wastewater, the SBBR containing a micro-organism or bacterium immobilized in polyvinyl alcohol (PVA) gel; a second settling tank, pump and filter connected to the SBBR for filtering the first stream after treatment by the SBBR and for providing a second stream of treated wastewater; an adsorption column connected to the second filter for receiving the second stream of treated wastewater and for providing a third stream of treated wastewater, the adsorption column containing granular activated carbon (GAC).

The system can have a plurality of electrocoagulation reactors operating in parallel, and/or a plurality of Spouted Bed Bio-Reactors operating in parallel and/or a plurality of adsorption columns operating in parallel.

The system can be continuous, in the sense that it is adapted to be connected to a source of contaminated wastewater stream on a continuous basis for receiving the contaminated water, decontaminating the water and outputting the decontaminated water.

Since the contaminated water passes through the electrocoagulation reactor(s) and the Spouted Bed Bio-Reactor(s) before reaching the adsorption column(s), the concentration of contaminants is substantially reduced before reaching the adsorption column(s). Thus, the granular activated carbon (GAC) of the adsorption column(s) can last for a longer period of time before being saturated by the contaminants. This helps reducing the cost of replacement of the GAC and results in a more efficient continuous system.

The contaminants comprise Chemical Oxygen Demand (COD), phenol and cresols. The concentration of contaminants can be reduced between 95% and 100%.

The concentration of the contaminants can be reduced by 97%, 100% and 99% for the COD, phenol and cresols, respectively.

For example, the input COD concentration, phenol concentration and cresols concentration can respectively be in the range of (4100-4200) ppm, (12) ppm and (72-75) ppm in the contaminated water and can respectively drop to less than (110) ppm, (0.0) ppm and (0.6) ppm after passing through the three stages, namely the electrocoagulation reactor, the SBBR and the adsorption column.

In fact, when the input COD, phenol and cresols concentrations are respectively in the range of (4200) ppm, (12) ppm and (75) ppm, they respectively drop to (2267) ppm, (64) ppm and (8) ppm after the first stage (electrocoagulation reactor); respectively drop to (1116) ppm, (4.8) ppm and (33) ppm after the second stage (SBBR); and respectively drop to (110) ppm, (0.0) ppm and (0.6) ppm after the third stage (Adsorption Column).

The granular activated carbon (GAC) can comprise lignan based activated carbon made by carbonating granules of lingin-based material. The lignin based activated carbon can be made of agricultural waste, such as date pits, which results in date pits activated carbon (DP-AC).

The granular activated carbon (GAC) can be made by carbonating material in a tube furnace purged with a flow of nitrogen for around 10 minutes, heated at a rate of around 10° C./min up to around 600° C., kept at the temperature for around 4 hours, left for cooling to room temperature, and then activated at a temperature of 900° C. using a flow of carbon dioxide and degassed under vacuum for around 2 hours.

The polyvinyl alcohol (PVA) can be made by mixing PVA powder with distilled water and bacterial suspension at around 70-80° C., stirred to ensure homogeneity, kept in a freezer at around −20° C. for around 24 hours and then left to thaw at around 4° C.

The micro-organism or bacterium immobilized in polyvinyl alcohol (PVA) can be Pseudomonas putida. The immobilized bacteria is preferably acclimatized to high phenol concentrations of up to 300 mg/l.

The Electrocoagulation reactor can comprise aluminium, steel or carbon electrode plates.

The SBBR can be made of a jacketed Plexiglas reactor configured to have a predetermined temperature controlled by water circulating around the Jacket. The predetermined temperature is preferably around 30° C.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

Further features and advantages of the present invention will become apparent from the following detailed description, taken in combination with the appended drawings, in which:

FIG. 1 is a schematic diagram of a system for reducing concentration of contaminants contained in a contaminated wastewater stream in accordance with one embodiment of the present invention;

FIG. 2 is a chart to illustrate and compare COD concentrations in a wastewater feed at the initial phase (before treatment) and after each treatment step carried out respectively by the Electrocoagulation Reactor, SBBR and the Adsorption Column;

FIG. 3 is a chart to illustrate and compare phenol and cresols concentrations in a wastewater feed at the initial phase (before treatment) and after each treatment step carried out respectively by the Electrocoagulation Reactor, SBBR and the Adsorption Column;

FIG. 4 is a chart to illustrate and compare the percentage of reduction of concentrations of COD and phenol after treatment carried out by the integrated system in accordance with the present invention from one side, and each of the conventional units used separately from another side; and

FIG. 5 is flow chart illustrating a process of reducing concentration of contaminants contained in a contaminated wastewater stream in accordance with one embodiment of the present invention.

### DETAILED DESCRIPTION OF THE INVENTION

### Bacterial Suspension

A special strain of the bacterium P. putida (A300) was obtained in a AMNITE cereal form from Cleveland Biotech Ltd., UK. A 100 g of the cereal was mixed in a 1 L of 0.22% sodium hexametaphosphate buffered with Na₂CO₃ to a pH of 8.5. The mixture was homogenized in a blender for about one hour, decanted and kept in the refrigerator at 4° C. for 24 hours. Bacteria slurry was prepared by first low speed centrifugation at 6000 rpm for 15 minutes. Then, the supernatant was collected and centrifuged again at 10,000 rpm for 20 minutes. Harvested bacteria cells were collected and kept in the refrigerator for immobilization.

### Immobilization of Bacteria in PVA Gel

Polyvinyl Alcohol (PVA) gel was used for immobilizing the bacteria cells. A homogenous PVA solution was prepared by mixing 100 g of PVA powder with 900 ml of distilled water at about 70-80° C. The formed mixture was allowed to cool to room temperature before adding 10 ml of the bacterial suspension, and then well stirred for 10 to 15 minutes to insure homogeneity of the whole solution. It was then poured into special molds and kept in a freezer at −20° C. for 24 hours, before it was transferred to the refrigerator and allowed to thaw at about 4° C. This gives the gel lower thawing rate and enhances the crystalline area formation, which increases the mechanical strength of the formed polymer. The freezing-thawing process was repeated three to four times for 5 hours for each cycle. The frozen gel molds were then cut into 1 cm³ cubes.

### Date Pits Activated Carbon

Date pits activated carbon (DP-AC) was prepared from raw date pits granules. The granules were washed, dried, grinded and screened. The collected granules were carbonated and activated to produce DP-AC. The carbonization is performed in a tube furnace (Thermolyene, USA) which has been initially purged with a flow of nitrogen for 10 minutes. After that, the furnace was heated at a rate of 10° C./min up to 600° C. and then kept at this temperature for 4 hours. After cooling to room temperature, the material is considered carbonized, but still inactive. After weighing the inactive carbon, it was activated in the same tube furnace at a temperature of 900° C. using a flow of carbon dioxide instead of nitrogen. The resulting AC was then degassed under vacuum (Shel Lab, USA) for about 2 hours before use.

### System/Process

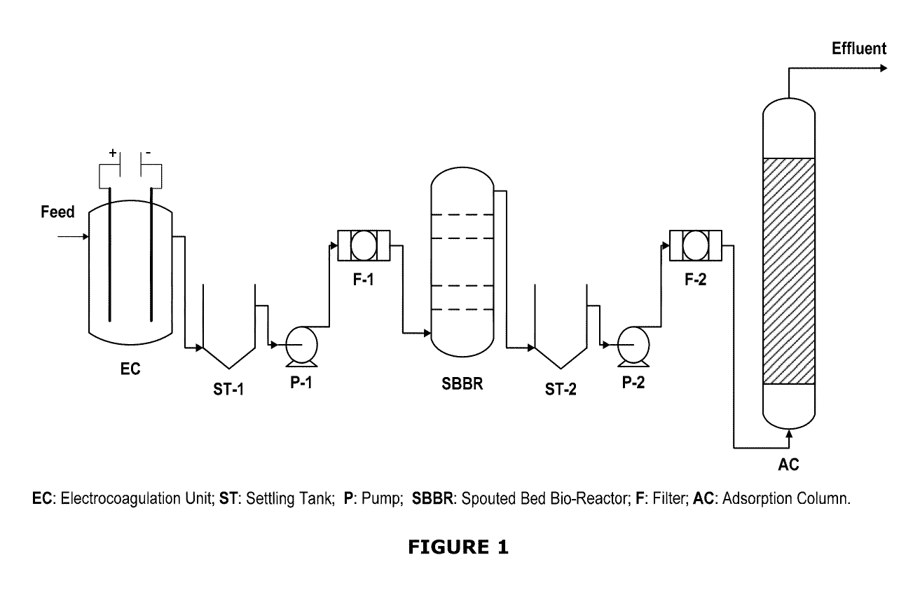

Refinery wastewater samples were treated using the integrated system (100) for reducing the concentration of contaminants contained in a contaminated wastewater stream (see FIG. 1).

As illustrated in FIG. 1, the system 100 comprises an electrocoagulation reactor 10, a first settling tank 12, a first pump 14, a first filter 16, a Spouted Bed Bio-Reactor (SBBR) 20, a second settling tank 22, a second pump 24, a second filter 26 and an adsorption column 30.

The electrocoagulation reactor 10 is adapted to be connected to a source of contaminated wastewater stream for coagulating dispersed particles contained in said contaminated wastewater.

The first settling tank 12, first pump 14 and first filter 16 are connected to said electrocoagulation reactor 10 for filtering said wastewater stream after electrocoagulation by removing said coagulated dispersed particles and for providing a first stream of treated wastewater after said first filtration.

The Spouted Bed Bio-Reactor (SBBR) 20 is connected to said first filter 16 for receiving said first stream of treated wastewater, said SBBR 20 containing pseudomonas putida immobilized in polyvinyl alcohol (PVA) gel.

The second settling tank 22, second pump 24 and second filter 26 are connected to said SBBR 20 for filtering said first stream after treatment by the SBBR and for providing a second stream of treated wastewater after said second filtration.

The adsorption column 30 is connected to said second filter 26 for receiving said second stream of treated wastewater, said adsorption column 30 containing granular activated carbon (GAC).

The wastewater was pumped to the electrocoagulation reactor 10 (14 cm in diameter and 6 cm height) using peristaltic pump (GILSON Miniplus 3—not shown) with a flow rate of 10 ml/min. Aluminum (or steel) plate electrodes (4 cm×6 cm×1 mm) were dipped into the wastewater sample and connected to a DC power source (POPULAR PE-23005) to provide the required current. The effluent from the electrocoagulation reactor 10 was sent to a first settling tank 12 and then pumped using a first pump 14 to a first filter 16 for filtration. The filtrate was then sent to the Spouted Bed Bioreactor (SBBR) 20. Air was continuously introduced through the bottom of the reactor at a flow rate of 3 l/min to enhance mixing and provide the necessary oxygen for the biodegradation process. The stream from the SBBR 20 was then fed to the second settling tank 22 and then pumped using the second pump 24 to the second filter 26 for filtration. The filtrate was then sent to the adsorption column 30, which is made of Plexiglas with 50 cm long and 3 cm inside diameter. The column was packed with 130 g of date pits activated carbon that has a particle size of 0.85-1.7 mm. At regular intervals, samples were collected from the effluent of each treatment unit and analyzed for COD, phenol and other phenols concentrations. All the experiments were carried out at room temperature.

The Electrocoagulation reactor 10, the SBBR 20 and the Adsorption column 30 are connected in series (Electro-Bio-Ads) and operated continuously to treat real refinery wastewater, which had a dark greenish color and a strong, pungent odor, with initial concentrations of 4190 mg/l, 12 mg/l and 73 mg/l for COD, phenol and cresols, respectively. The samples withdrawn after each treatment unit were analyzed for their COD content, phenol and cresols concentrations as a function of time. Table 1 summarizes conditions used in the experiments.

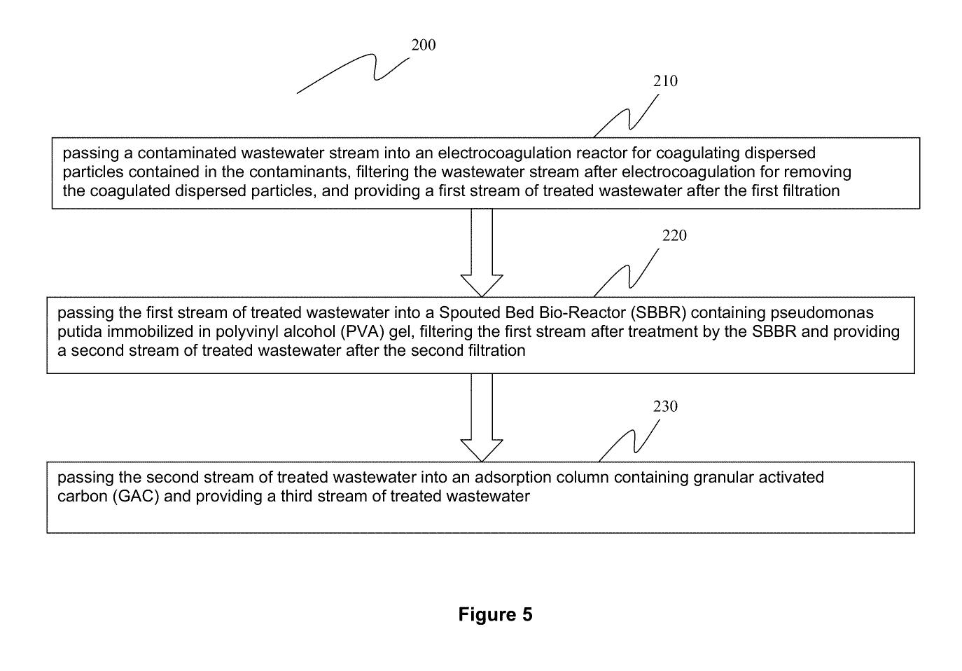

FIG. 5 illustrates the process of reducing concentration of contaminants contained in a contaminated wastewater stream in accordance with one embodiment of the present invention 200, which comprises:

First, passing the contaminated wastewater stream into an electrocoagulation reactor for coagulating dispersed particles in the contaminated wastewater, filtering the wastewater stream after electrocoagulation for removing the coagulated dispersed particles, and providing a first stream of treated wastewater after the first filtration 210;

Second, passing the first stream of treated wastewater into a Spouted Bed Bio-Reactor (SBBR) containing pseudomonas putida immobilized in polyvinyl alcohol (PVA) gel, filtering the first stream after treatment by the SBBR and providing a second stream of treated wastewater after the second filtration 220; and

Third, passing the second stream of treated wastewater into an adsorption column containing granular activated carbon (GAC) and providing a third stream of treated wastewater 230.

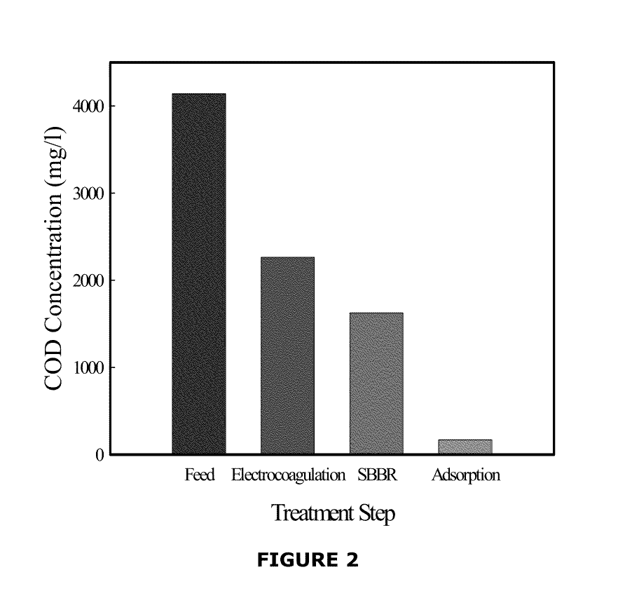

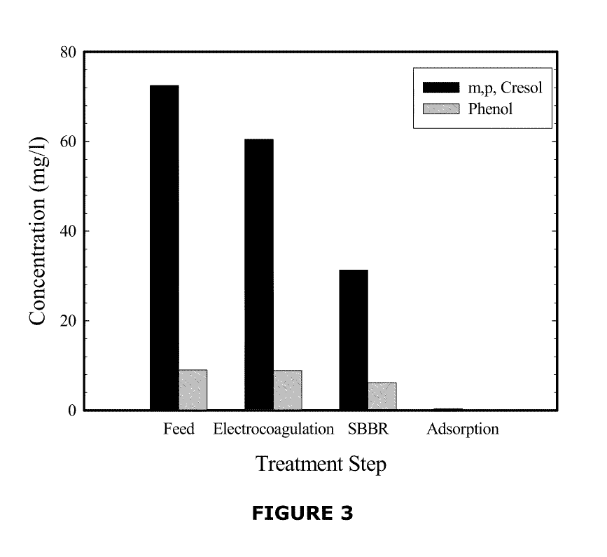

FIGS. 2 and 3 show the effluent concentrations of COD, phenol and cresols at steady state conditions for electrocoagulation and after 24 hours of operation for both biodegradation and adsorption systems. The results show that the electrocoagulation unit reduced the COD concentration by about 46%, the phenol by 33% and the cresols by 15%. The bioreactor further reduced the feed contaminants by 73%, 61% and 56% for COD, phenol and cresols, respectively. Nevertheless, most of the reduction in COD and other phenols has taken place in the adsorption unit, where the final cumulative reduction reached 97%, 100%, and 99% for COD phenol and cresol, respectively. The final effluent after the adsorption column had COD and phenol concentrations that are within the acceptable discharge limits. A summary of the complete system results are shown in Table 2, and the cumulative % reduction after each treatment step are shown in Table 3.

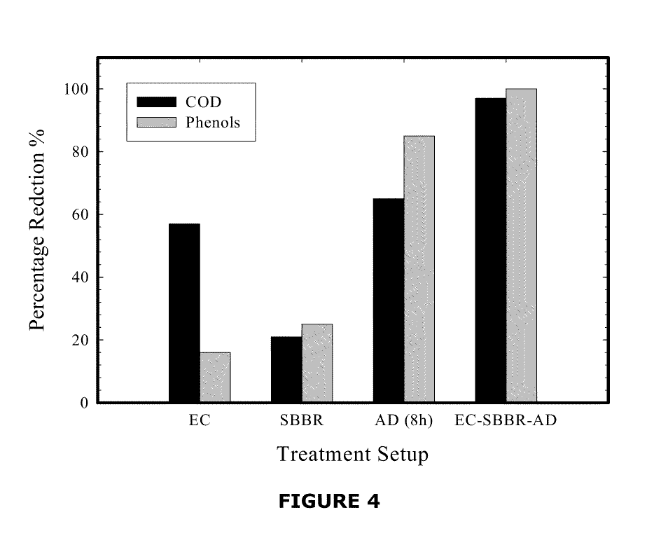

The performance of each individual unit in treating the refinery wastewater feed was compared with that of the three-step system, using different arrangements of the units. The best performance of each unit and the best performance of the three-unit system are shown in FIG. 4. The three-step process, with the arrangement shown in FIG. 1, is superior to any of the individual units. This arrangement proved to be effective in reducing the concentrations of COD and phenol and was operated efficiently for a period of 24 hours.

TABLE 1
Operating conditions for the three unit system

| Electrocoagulation | SBBR | Adsorption system |
|---|---|---|
| Electrodes Type: | PVA amount: | Adsorbent: DP-AC |
| Aluminum | 30 Vol % | |
| Current density: | Temperature: | Adsorbent mass: |
| 3 mA/cm² | 30° C. | 130 g |
| Current: 100 mA | pH: 7.5 | Room Temperature |
| Area of the electrodes: | Air flow rate: | Liquid Flow rate: |
| 36 cm² | 3 ml/min | 10 ml/min |
| Liquid Flow rate: | Liquid flow rate: | |
| 10 ml/min | 10 ml/min | |

TABLE 2
Summary of the results of EC-SBBR-AD treatment system

| | Electrocoagulation | | SBBR | | Adsorption | |
|---|---|---|---|---|---|---|
| Test | In | Out | In | Out | In | Out |
| pH | 7.2 | 9.1 | 7.8 | 8.2 | 8.2 | 8.2 |
| Conduc- | 5.4 | 6.2 | 6.2 | 6.73 | 6.73 | 8.24 |
| tivity (mS) | | | | | | |
| TSS (g/l) | 0.072 | 0.244 | 0.11 | 0.17 | 0.05 | 0.01 |
| TDS (g/l) | 3.38 | 3.6 | 3.6 | 4.03 | 4.03 | 4.95 |
| COD | 4190 | 2267 | 2267 | 1116 | 1116 | 110 |
| (mg/l) | | | | | | |
| Phenol | 12.2 | 8.1 | 8.1 | 4.8 | 4.8 | 0 |
| (mg/l) | | | | | | |
| Cresols | 75 | 64 | 64 | 33 | 33 | 0.6 |
| (mg/l) | | | | | | |

TABLE 3
Cumulative % reduction after each treatment
step after 24 h of operation

| | Electrocoagulation | SBBR | Adsorption |
|---|---|---|---|
| COD | 46 | 73 | 97 |
| Phenol | 33 | 61 | 100 |
| Cresols | 15 | 56 | 99 |

Although, the figures, rates, flows, dimensions, concentrations and other numbers presented hereinabove have been used to prove the concept of the invention, they apply for the experimental set-up only and should not be construed for limiting the scope of the invention. They can be scaled up for commercial scale processing without departing from the scope of the present invention.

Although the above description contains many specificities, these should not be construed as limitations on the scope of the invention but is merely representative of the presently preferred embodiments of this invention. The embodiment(s) of the invention described above is (are) intended to be exemplary only.

The scope of the invention is therefore intended to be limited solely by the scope of the appended claims.

1. A process of reducing concentration of contaminants contained in a contaminated wastewater stream output from a refinery, the process comprising:
first, passing the contaminated wastewater stream into an electrocoagulation reactor for coagulating dispersed particles contained in said contaminated wastewater stream, filtering said wastewater stream after electrocoagulation for removing said coagulated dispersed particles, and providing a first stream of treated wastewater after said first filtration;
second, passing said first stream of treated wastewater into a Spouted Bed Bio-Reactor (SBBR) containing a micro-organism or bacterium immobilized in polyvinyl alcohol (PVA) gel, filtering said first stream after treatment by the SBBR and providing a second stream of treated wastewater after said second filtration; and
third, passing said second stream of treated wastewater into an adsorption column containing granular activated carbon (GAC) and providing a third stream of treated wastewater.

2. The process as claimed in claim 1, wherein said contaminants comprise Chemical Oxygen Demand (COD), phenol and cresols.

3. The process as claimed in claim 2, wherein said concentration of contaminants is reduced between 95% and 100%.

4. The process as claimed in claim 3, wherein said concentration of contaminants is reduced by 97%, 100% and 99% for said COD, phenol and cresol respectively.

5. The process as claimed in claim 1, wherein said granular activated carbon (GAC) comprises lignin based activated carbon made by carbonating granules of lignin-based material.

6. The process as claimed in claim 5, wherein said granular activated carbon (GAC) is made by carbonating material in a tube furnace purged with a flow of nitrogen for around 10 minutes, heated at a rate of around 10° C./min up to around 600° C., kept at said temperature for around 4 hours, left for cooling to room temperature, and then activated at a temperature of 900° C. using a flow of carbon dioxide and degassed under vacuum for around 2 hours.

7. The process as claimed in claim 6, wherein said lignin based activated carbon includes date pits activated carbon (DP-AC).

8. The process as claimed in claim 1, wherein said polyvinyl alcohol (PVA) is made by mixing PVA powder with distilled water and suspension at around 70-80° C., stirred to ensure homogeneity, kept in a freezer at around −20° C. for around 24 hours and then left to thaw at around 4° C.

9. A system for reducing concentration of contaminants contained in a contaminated wastewater stream output from a refinery, the system comprising:
an electrocoagulation reactor adapted to be connected to a source of contaminated wastewater stream for coagulating dispersed particles contained in said contaminated wastewater stream;
a first settling tank, pump and filter connected to said electrocoagulation reactor for filtering said wastewater stream after electrocoagulation by removing said coagulated dispersed particles and for providing a first stream of treated wastewater after said first filtration;
a Spouted Bed Bio-Reactor (SBBR) connected to said first filter for receiving said first stream of treated wastewater, said SBBR containing a micro-organism or bacterium immobilized in polyvinyl alcohol (PVA) gel;
a second settling tank, pump and filter connected to said SBBR for filtering said first stream after treatment by the SBBR and for providing a second stream of treated wastewater after said second filtration; and
an adsorption column connected to said second filter for receiving said second stream of treated wastewater and for providing a third stream of treated wastewater, said adsorption column containing granular activated carbon (GAC).

10. The system as claimed in claim 9, wherein said Electrocoagulation reactor comprises aluminium or steel electrode plates.

11. The system as claimed in claim 9, wherein said SBBR is made of a jacketed Plexiglas reactor configured to have a predetermined temperature controlled by water circulating around said Jacket.

12. The system as claimed in claim 11, wherein said predetermined temperature is around 30° C.

13. The system as claimed in claim 9, wherein said contaminants comprise Chemical Oxygen Demand (COD), phenol and cresols.

14. The system as claimed in claim 13, wherein said concentration of contaminants is reduced between 95% and 100%.

15. The system as claimed in claim 14, wherein said concentration of contaminants is reduced by 97%, 100% and 99% for COD, phenol and cresols, respectively.

16. The system as claimed in claim 15, wherein said COD, phenol and cresols have an initial concentration of at least 4000 mg/L, 12 mg/L and 75 mg/L respectively.
